(19) United States
(12) Patent Application Publication
(10) Pub. No.: US 2005/0041251 A1
(43) Pub. Date: Feb. 24, 2005

(54) Method and apparatus for measuring loading of waterproofing agent in carbon substrate

(76) Inventors: Hong Cao, Burnaby (CA); Juergen Stumper, Vancouver (CA); David S. De Haan, Burnaby (CA)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/644,072

(22) Filed: Aug. 18, 2003

(51) Int. Cl. G01N 21/00

(52) U.S. Cl. 356/433

(57) ABSTRACT

A method for determining the degree of loading of a waterproofing agent within a planar carbon substrate by measuring the transmittance of light through the carbon substrate when in an unloaded state, measuring the transmittance of light through the carbon substrate when in a loaded state, and comparing the difference in transmittance from the unloaded state to the loaded state and therefrom determining the degree of loading is disclosed. An apparatus for measuring the degree of loading of a waterproofing agent within a planar carbon substrate is also disclosed.

### BACKGROUND OF THE INVENTION

1. Field of the Invention

This invention generally relates to a method and apparatus for measuring the loading of a waterproofing agent, such as polytetrafluorethylene (PTFE), within a carbon substrate used in the manufacture of a gas diffusion electrode for an electrochemical fuel cell.

2. Description of the Related Art

Electrochemical fuel cells, particularly those that use a proton exchange membrane (“PEM”), have received considerable attention over the last decade due to their ability to generate electricity in a clean and efficient manner. In general, hydrogen fuel (typically obtained from natural gas, methanol or petroleum) and oxygen (from the air) combine in the fuel cell to produce electricity, with heat and water being the only by-products. Fundamental components of an electrochemical fuel cell include two electrodes—the anode and cathode—separated by a PEM. Each electrode is coated on one side with a thin layer of platinum catalyst, with the PEM being “sandwiched” between the two electrodes and in contact with the catalyst layers. The anode/PEM/cathode combination is referred to as the membrane electrode assembly (“MEA”).

Hydrogen fuel dissociates into free electrons and protons upon contact with the catalyst on the anode-side of the PEM. The protons migrate through the PEM, while the free electrons are conducted from the anode, in the form of usable electric current, through an external circuit to the cathode. On the cathode-side of the PEM, oxygen from the air, electrons from the external circuit, and protons that pass through the PEM combine (with the assistance of the cathode catalyst) to form water and heat. The hydrogen fuel and oxygen (i.e., air) are supplied to the anode and cathode, respectively, through channels formed in what are called “flow field plates.” Since these gases must diffuse though the anode and cathode to reach the catalyst layer, it is common to refer to the anode and cathode as a gas diffusion electrode (“GDE”).

The most common GDEs employ carbon fiber paper or carbon cloth as a backing layer or substrate. To that end, carbon fiber paper that has been sintered at a high temperature offers a fairly rigid and highly conductive substrate. Carbon cloth is generally more flexible than carbon fiber paper, and also offers a high level of conductivity. In order to reduce cost of production, a poorly conductive carbon web (e.g., a non-woven web) may be impregnated with an electrically conductive filler, such as carbon powder, and then heated. This “carbonizing” step imparts the desired electrical conductivity while reducing substrate manufacturing costs.

The electrically conductive carbon substrate of the GDE is typically treated with a waterproofing agent in order to render it more hydrophobic. One of the most common waterproofing agents is polytetrafluoroethylene (PTFE). In operation of an electrochemical fuel cell, it is desirable to carry water away from the electrolyte surface, particular away from the cathode catalyst where water is produced as a reaction by-product. Especially in the context of large scale manufacturing, consistency in the amount of PTFE loaded within the carbon substrate is important in order to yield MEAs, and thus fuel cells, have reproducible and known characteristics.

Existing techniques for measuring the amount of PTFE loaded within the carbon substrate are problematic. For example, several monitoring techniques, which involve heating the carbon substrate sample to above about 600° C. in a non-oxidized atmosphere, such as N₂ or H₂, thereby leading to the burn-off of the loaded PTFE, are destructive to the carbon substrate. In these techniques, the amount of PTFE loading is determined by measuring the weight loss of the carbon substrate sample. The weight loss may be determined by measuring the weight of the carbon substrate sample both before and after heating or by continuously monitoring the sample weight during the heating process.

Other techniques for measuring the amount of PTFE loaded within the carbon substrate, while not destructive to the carbon substrate, are still problematic. For example, a gamma backscatter gage, which detects the amount and energy of backscattered gamma rays (i.e., photons), may be used to measure the mass (or weight per unit area) change due to the PTFE loading. However, the accuracy of a gamma backscatter gage decreases with the amount of PTFE loading and is not sufficiently accurate for low PTFE loadings (e.g., less than 12% by weight). Alternatively, by simply weighing the carbon substrate before and after loading with PTFE, one can determine the amount of the total weight of loaded PTFE. However, since this technique only measures the total loading, it can not be used to determine the local PTFE loading, which shows whether the PTFE loading is uniformly distributed within the carbon substrate.

Accordingly, there is a need in the art for improved methods and apparatus for measuring the loading of a waterproofing agent such as PTFE within a carbon substrate, particularly in the context of a carbon substrate used within the GDE of an electrochemical fuel cell. Preferably, such methods and apparatus should be non-destructive to the waterproofing agent-loaded carbon substrate. The present invention fulfills these and other related needs.

### BRIEF SUMMARY OF THE INVENTION

In brief, the present invention provides methods and apparatus for measuring the loading of a waterproofing agent, such as polytetrafluorethylene (PTFE), within a carbon substrate used in the manufacture of a gas diffusion electrode (GDE) for an electrochemical fuel cell.

In one embodiment, the method involves determining the degree of loading of a waterproofing agent within a planar carbon substrate by measuring the transmittance of light through the carbon substrate when in an unloaded state and in a loaded state, and from such measurements determining the degree of loading.

These and other aspects of the invention will be evident upon reference to the attached drawings and following detailed description.

### BRIEF DESCRIPTION OF THE SEVERAL VIEWS OF THE DRAWING(S)

FIG. 1 illustrates an apparatus for measuring the loading of a carbon substrate according to an embodiment of this invention.

FIG. 2 is a graph showing the relationship between the amount of PTFE loading (wt %) and the change in light transmittance.

### DETAILED DESCRIPTION OF THE INVENTION

This invention generally relates to a method and apparatus for measuring the loading of a waterproofing agent within a carbon substrate used in the manufacture of a GDE for an electrochemical fuel cell. As noted above, in operation of an electrochemical fuel cell, it is desirable to carry water away from the electrolyte surface, particular away from the cathode catalyst where water is produced as a reaction by-product.

A GDE carbon substrate is typically a carbon fiber paper or carbon cloth. Suitable carbon fiber paper is sold by Toray under the trade name TGP-H-60, while carbon cloth is available from Ballard Material Products under the trade name AvCarb™ carbon fabric. In order to reduce manufacturing costs, a non-conductive continuous carbon web may be also be used by carbonizing the web by addition of a conductive filler, such as a carbon powder, followed be heating at high temperature. Suitable carbon substrates generally have a thickness of less than 0.5 mm, generally from 0.1 mm to 0.4 mm, and typically from 0.15 mm to 0.25 mm. If the carbon substrate is too thick (e.g., greater than 0.5 mm), the light transmittance may be too small to detect any change in transmittance due to the PTFE coating.

Representative waterproofing agents in this regard include polytetrafluoroethylene (PTFE). However, other waterproofing agents may also be employed, including mixtures of the same with PTFE. For example, other waterproofing agents include fluorinated ethylene-propylene (FEP) copolymer, polyethylene, polypropylene and ethylene-propylene copolymer. While the remainder of this specification will sometimes refer to the waterproofing agent as PTFE, it should be understood that the invention is not limited to this specific agent.

The carbon substrate is typically treated with a solution of PTFE and then sintered at about 300-400° C. This results in the carbon substrate containing generally from about 1-50% by weight PTFE, and typically from about 4-30% by weight PTFE.

The carbon substrate loaded with PTFE may then be further processed to prepare the anode and cathode GDE, including application of a carbon layer and a catalyst layer and forming of an MEA by “sandwiching” the PEM between the anode GDE and cathode GDE. The resulting MEA may then be incorporated into the construction of a fuel cell which, in turn, may be used as a component of a fuel cell stacks for a wide variety of applications, including stationary and mobile (e.g., automotive) use.

Knowing the amount of PTFE loaded within the carbon fiber substrate is important for maintaining consistency in manufacture of a GDE and, in turn, of a MEA, as well as corresponding fuel cells, fuel cell stacks, and related products and systems containing the same. In that regard, the ability to measure the amount of PTFE within the carbon substrate in a non-destructive and continuous manner is also beneficial. In the practice of this invention, such measurement is generally accomplished by measuring the transmittance of light through the carbon substrate, and therefrom determining the amount of PTFE loaded therein.

More specifically, and in one embodiment, a method is disclosed for measuring the loading of a waterproofing agent such as PTFE within a carbon substrate used in the manufacture of a GDE for an electrochemical fuel cell by measuring the transmittance of light through the carbon substrate when in an unloaded state and in a loaded state, and then determining the degree of loading from the difference in transmittance from the unloaded state to the loaded state. In this method, as the loading of the carbon substrate with the PTFE increases, the transmittance of light through the carbon substrate decreases.

It has been surprisingly discovered that the amount of light transmitted through the carbon substrate is indicative of PTFE loading. Since the carbon substrate itself is black, transmission of light through the substrate occurs by multiple reflections and/or scattering. Loading of PTFE occurs within the carbon substrate (as opposed to just surface coating), which results in the carbon fibers themselves being covered and a filling of any voids between fibers. This reduces the ability of the light to reflect/scatter through the carbon substrate. Thus, by measuring the transmittance in an unloaded state, and then comparing the same to the reduced level of transmittance observed in a loaded state, the amount of loading can be determined.

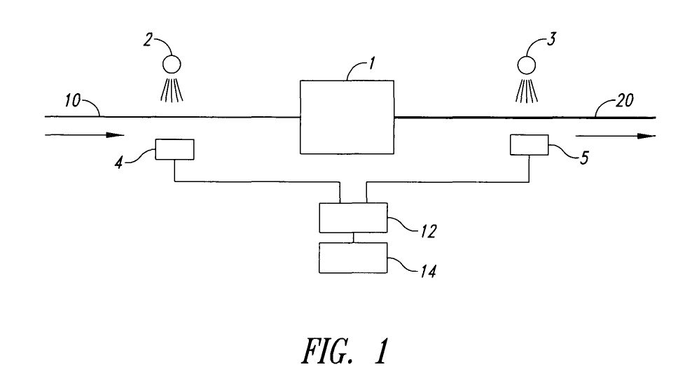

A representative apparatus for measuring the transmittance of light through the loaded or unloaded carbon substrate is presented in FIG. 1. Planar carbon substrate 10 in an unloaded state is loaded with PTFE by an appropriate means, as depicted by box 1. Suitable loading means in this regard are known to those skilled in the art and include, for example, dipping and dripping, spraying, knife coating, reverse roller coating or double roller coating followed by sintering at about 300-450° C. in air. Following loading, carbon substrate in a loaded state is depicted as sheet 20. While loading of the carbon substrate may occur in a batch process, in a more specific embodiment loading may be achieved in a continuous manner as the carbon substrate travels in the direction noted by the arrows. Light sources 2 and 3 irradiate one side of unloaded substrate 10 and loaded substrate 20, respectively. Suitable light sources, having both high illumination and stable light intensity, include halogen, tungsten, fluorescent and UV lamps. Light meters 4 and 5, comprising photovoltanic sensor cells (not specifically shown), detect the amount of light, typically at 4000 to 7000 Å, passing through unloaded substrate 10 and loaded substrate 20, respectively, from the opposite side of unloaded substrate 10 and loaded substrate 20. Output from such light meters may be manually read (not shown) or passed to an appropriate data acquisition device 12 and computer 14 for appropriate interpretation, storage and/or display.

The PTFE content of the loaded substrate may be determined by the following equations (1) and (2):
PTFE Content (wt %)={(W_{loaded}−W_{unloaded})/W_{loaded}}*100 (1)
Transmission_{diff}=L_{loaded}−L_{unloaded} (2)
PTFE Content (wt %)=Const*Transmission_{diff} (3)

In Equation (1), W_{loaded} is the weight of the carbon substrate in a loaded condition, and W_{unloaded} is the weight of the carbon substrate in an unloaded condition. Further, in Equation (2), Transmission_{diff} is the difference in transmission, L_{loaded} is the transmitted light intensity of the carbon substrate in the loaded condition, and L_{unloaded} in the transmitted light intensity of the carbon substrate in the unloaded condition. In Equation (3), Const is a calibration factor determined by measuring the PTFE Content and the Transmission_{diff} for a reference carbon substrate sample.

The degree of loading of the waterproofing agent, such as PTFE within a carbon substrate, might also be determined by measuring the transmittance of light through the carbon substrate in a loaded state at both a first wavelength and a second wavelength that is different from the first wavelength. The level of transmittance at the first wavelength and second wavelength is a function of the amount of C—C and C—F bonds, respectively, within the loaded carbon substrate. Since the transmittance of light is compared at two different wavelengths, measuring the transmittance of light through the carbon substrate in an unloaded state for comparison and calibration purposes might be avoided.

Still further, rather than measuring the transmittance of light through the carbon substrate, the amount of light reflected by the carbon substrate might be considered to measure the loading of the waterproofing agent.

The following example is offered by way of illustration, not limitation.

### EXAMPLE

### Example 1

In this example, the carbon substrate used was Toray carbon fiber paper, available under the trade name TGP-H-60. Two types of light sources were used, a high light intensity source (3M, model number 9050) and a low light intensity source (Mitutoyo, model number PO-6000-D). The distances between the light sources, light meters and carbon substrate sample were kept constant at about 5-10 cm and 0-5 mm, respectively.

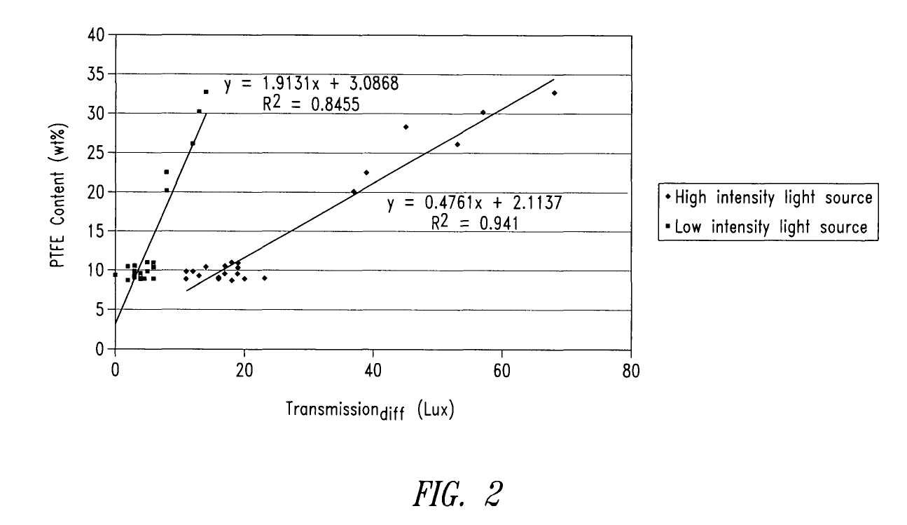

The light transmittance, of both the high intensity and low intensity light sources, through a particular area of the sample was measured both before and after PTFE loading. FIG. 2 shows the relationship between the amount of PTFE loading (wt %) and the change in light transmittance for each of the two different light source intensities. As shown in FIG. 2, the change in light transmittance is proportional to the amount of PTFE loading. Furthermore, as shown in FIG. 2, measurements employing the high intensity light source show a higher sensitivity to changes in the amount of PTFE loading (i.e., for the same change in PTFE loading, the high intensity source shows a greater change in light transmittance).

The amount of PTFE loading in FIG. 2 was measured by the burn-off process described previously (i.e., the sample was heated to above about 600° C. in a non-oxidizing atmosphere, such as N₂ or H₂, thereby to the burn-off of the loaded PTFE and the weight loss of the sample as a resulting of such heating was measured).

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for determining the degree of loading of a waterproofing agent within a planar carbon substrate, comprising the steps of:
measuring the transmittance of light through the carbon substrate when in an unloaded state;
measuring the transmittance of light through the carbon substrate when in a loaded state; and
comparing the difference in transmittance from the unloaded state to the loaded state and therefrom determining the degree of loading.

2. The method of claim 1 wherein the carbon substrate is a carbon fiber paper.

3. The method of claim 1 wherein the carbon substrate is a carbon cloth.

4. The method of claim 1 wherein the carbon substrate is a continuous web impregnated with an electrically conductive filler.

5. The method of claim 1 wherein the waterproofing agent is polytetrafluorethylene.

6. The method of claim 1 wherein the waterproofing agent is selected from the group consisting of polyethylene, polypropylene and ethylene-propylene copolymer.

7. The method of claim 1 wherein the degree of loading of the waterproofing agent within the carbon substrate when in the loaded state ranges from 1% to 50% by weight.

8. The method of claim 1 wherein the degree of loading of the waterproofing agent within the carbon substrate when in the loaded state ranges from 4% to 30% by weight.

9. The method of claim 1 wherein transmittance is measured at 4000 to 7000 Å.

10. The method of claim 1 wherein light is provided by a light source selected from the group consisting of halogen, tungsten, fluorescent and UV lamps.

11. The method of claim 1 wherein the carbon substrate has a thickness of less than 0.5 mm.
